(19) United States
(12) Patent Application Publication
(10) Pub. No.: US 2009/0099928 A1
(43) Pub. Date: Apr. 16, 2009

(54) Method for Video Game Advertising

(76) Inventor: Manuel Vasile, Cape Coral, FL (US)

Correspondence Address: GREENBERG & LIEBERMAN, LLC, 2141 WISCONSIN AVE, N.W., SUITE C-2, WASHINGTON, DC, 20007, US

(21) Appl. No.: 12/253,007

(22) Filed: Oct. 16, 2008

Related U.S. Application Data
(60) Provisional application No. 60/980,219, filed on Oct. 16, 2007.

(51) Int. Cl. G06Q 30/00; A63F 13/00

(52) U.S. Cl. 705/14; 463/31

(57) ABSTRACT

An advertising method enabling advertisers and marketers to insert computer graphics animation into targeted interludes of video and computer games where gamers will have the opportunity to briefly use their game characters' attributes in an interactive mini game while also being exposed to the advertising company's product. The setting of the video or computer game can also be replicated in the advertising method.

This is a non-provisional application of provisional application No. 60/980,219 filed on Oct. 16, 2007, and priority is claimed thereto.

### FIELD OF THE INVENTION

The present invention enables advertisers and marketers to insert computer graphics animation into select phases of video and computer games to be intertwined with the primary program in an interactive manner with the gamer.

### BACKGROUND OF THE INVENTION

Marketers are constantly seeking unique and novel methods of integrating advertisements with video games. The general concept is quite intelligent considering the video game market is comprised of the most lucrative target audiences. Because of this, various subtle and not-so-subtle advertisements have found their way into these games.

One common method is to program banner ads into sports video games. Other methods consist of virtual product placement within video games. These methods continue to retain traditional viewer attributes as seen in television advertisements. In this regard, advertisements within video games are not interactive and do not encompass deeper involvement with the gamer beyond mere viewership. Because of this fact, there is a need for a business method that integrates advertisements into video games with the capability to actually pull individual attributes from the character or team being controlled by the gamer for an interactive advertiser interlude.

Internet advertisers use a form of interactive display to attract users to various Web sites. This includes trivia questions and dancing animals. However, these methods are not truly interactive because they are designed only to compel the user to click on the advertisement. Once clicked, the user is taken to a different Web site. This method has proven successful to lure potential Web site viewers but is far from engaging in terms of actual interaction through memory attributes beyond cookies and basic Internet protocols. Relating to video and computer games, there remains a need for a business method that can allow a gamer to participate in a venerable game within a game that can feed off of user-initiated data.

### SUMMARY OF THE PRESENT INVENTION

The present invention is a business method that employs computer graphics animation into various phases of video and computer games. This computer graphics animation can match the graphics quality of these video games or lessen the quality for such motivations as artistic effect. Instead of traditional producers of television advertisements, the present invention permits this computer graphics animation to be designed and programmed by the game designers, who should already posses the technical expertise. Advertisers, of course, may consult and assist the plot developers in expressing their desires in order to best suit their promotional interests. By advertisers and plot developers working together, more natural interactive interludes can be developed.

The computer graphics animation can come in the form of a brief, 60-second mini-game at some natural break point in the overall game. For example, halftime during a football game can use an advertising spot featuring a field goal kicking contest or passing competition that integrates weather and gamer custom features from the overall game. An additional example is for a skateboarding or other extreme sports game. In this example, every time a gamer finishes a level from the overall game, the gamer is directed to a computer graphics animation where the gamer assumes his or her previously created overall game identity and attributes in order to attempt a vastly difficult sporting maneuver. Before, during and after this maneuver, which is controlled by the gamer, the product logo can be featured, with the product catch phrase appearing either visually or audibly after completion or failure of the maneuver.

From the previous example, we see that advertisers can ingratiate the product into a short interlude from the overall game. The interlude of the present invention does not affect any aspect of the overall game but does expose the gamer to the product in an interactive and also captive-audience manner. The present invention also takes into account the gamer's game choices, attributes, game accomplishments and other items related to that gaming session. These factors can then be employed into various skill and scenario mini games or events that make up the interactive advertisements featured at the natural interludes in the video game.

### BRIEF DESCRIPTION OF THE DRAWINGS

FIG. 1 is a flow chart of the programming and business process of the present invention.

FIG. 2 is a flow chart of the play of the overall game and integration with the advertisement.

### DETAILED DESCRIPTION OF THE PREFERRED EMBODIMENT

The present invention permits advertisers to incorporate their products into various natural interludes of video or computer games. This incorporation is interactive and has the ability to employ individual gamer attributes from the overall game. In this manner, the gamer can play a brief mini game in between game levels or sports quarters that serves to engage the gamer while also expose the gamer to the product. The present invention allows video game makers and advertisers to work together as the game makers may charge fees from the advertisers to have their products included in the video games while advertisers have the potential for mass-media exposure.

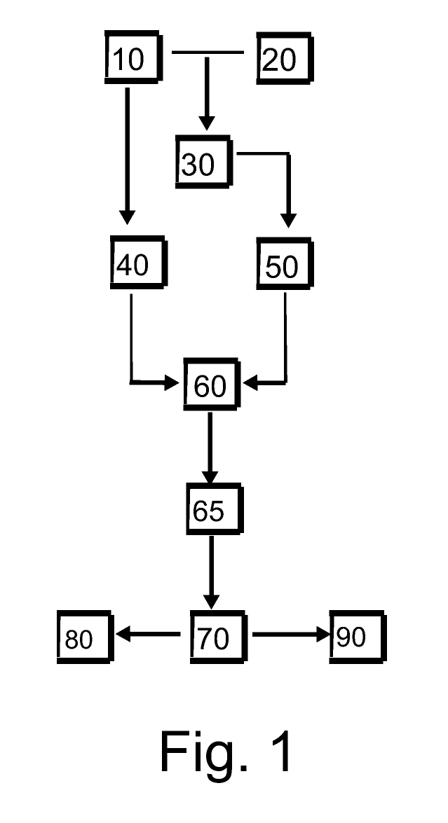

FIG. 1 shows us a flow chart of the programming and business process of the present invention. The present invention relating to the conceived advertising campaign (20) typically will begin on a different track than the conceived video game (10). The conceived video game (10) can be independently evolved into the overall game program (40). Many video games possess natural breaks where the advertising elements can be inserted after the overall video game is nearly complete. These natural breaks can be the end of a quarter or halftime for a football game, end of a period in a hockey game or between innings or even the 7^{th} inning stretch of a baseball game. A natural break also can include the point where the gamer defeats a boss character to move to a higher level of the overall game or upon some significant victory or achievement in a role-playing game.

While the conceived video game (10) is being formulated, the conceived advertising campaign (20) also can be developed. Once the respective concepts are initiated, a consultation (30) is implemented. This consultation (30) is between the advertisers and the video game designers. During the consultation (30), details such as computer graphic animation, timing, placement and compatibility between the overall video game and the advertisement are determined. Once these elements are determined, the advertisement design and programming (50) is commenced. Typically, the advertisement design and programming (50) may be performed by the overall game designers via conventional means. This ensures that the computer graphics animation of the advertising interlude will mirror the look and feel of the overall video game. Seamless look and feel is important because in most cases, the advertiser does not want the gamer to feel like he or she is part of an advertisement but rather involved in a mini game interlude at a natural break from the overall video game. It also should be noted that the present invention commences an advertisement design and programming, resulting in combining the conceived video game with the conceived advertising campaign.

With the advertisement design and programming (50), the designers also can conventionally establish the attributes integration (60). The attributes integration (60) incorporates data from the overall video game and establishes a conduit where that data can be harnessed to help shape the advertising interlude. This data can be a character profile, both physical and functional, that is created by the gamer at the outset of the overall video game. The data also can relate to various achievements, abilities, choices or other elements directly associated to the gamer's actions within the overall video game.

At this point, the advertising design, along with the attributes integration (60), is programmed into the overall video game (65). With the finished product that includes the overall video game and advertising interludes, the video game is ready for use by the gamer (70). An additional embodiment of the present invention includes changing or swapping computer graphics animation used by the gamer (70) for newer, updated or otherwise other versions via an Internet transfer (80). The conventional Internet transfer (80) can provide the gamer with different at least one advertising interlude scenario or challenge, as well as different products or slogans. If the advertising interlude becomes part of popular culture or otherwise popular, some kind of fee structure for the download also may be employed. An additional embodiment of the present invention relating to popularity of an advertisement mini game or interlude also can spawn the creation of a new, more complete game (90). In this embodiment, the advertising interludes have the potential to catch on with the gamers to create lucrative overall games featuring the product.

An additional embodiment of the present invention is more traditional in that the computer graphics animation advertising interludes can mirror advertisements from television, radio, the Internet or virtually any other medium. In this manner, the gamer would briefly be a captive audience to the advertising spot. An additional embodiment based on this more traditional approach relates to the same type of traditional commercial within the overall video game, but taking attributes (also referred to as gamer information) such as the gamer's character name or other feature to include within the pre-ordained and less interactive advertisement.

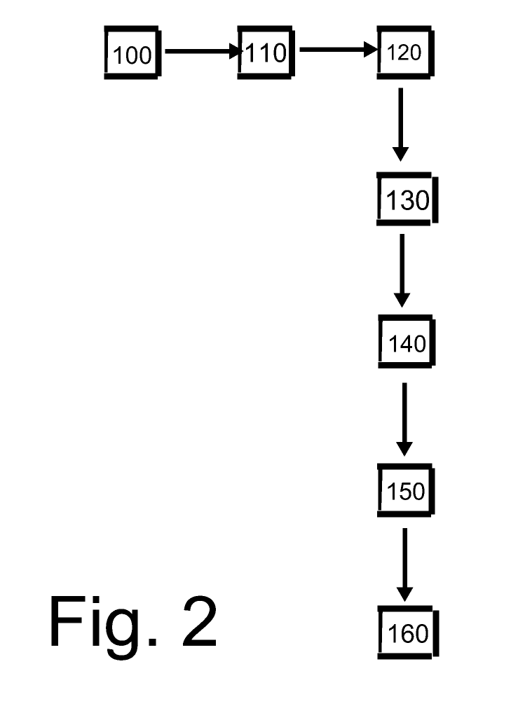

In FIG. 2, we see a flow chart of the play of a typical overall video game along with the incorporation of the advertising interlude. The first step in regard to play is for the gamer to start the overall video game (100). This includes such items as character creation, settings, team names, personal attributes and many other potential video game concepts. Once these aspects are hashed through or logged, the gamer will play through missions or sporting events (110) depending on the type of game. The gamer's character may lose a life, succeed, fail or otherwise slog through the game's programming during this phase of the overall video game with no regard to advertising. But once a significant event occurs, such as victory in a game level or halftime in a football game, a natural break in the overall video game (120) occurs. At this point, the advertising interlude begins (130). The advertising interlude (130) can be an independent mini game, trivia contest or any other interactive program. Celebrity and sports likenesses also can be included in the computer graphics animation if feasible for that specific advertising campaign. The gamer at this time also may be exposed to the product. The gamer may then begin play (140) of this advertising interlude. The advertising interlude does not impact the overall game, but its brief play may still incorporate various attributes from the overall game. The advertising interlude then will be completed (150). It is the advertisers' and designers' prerogative on how or when they want the product image, slogan or other exposure to be displayed during this advertising interlude. But once the advertising interlude is completed (150), the gamer will then begin the next level or segment of the overall video game (160).

There are numerous applications of the present invention relating to the content, fee structure and quality of computer graphic animation. An example to better illustrate a possible scenario featuring the present invention is as follows. An advertising company selling protective gear for athletes may wish to target gamers who will purchase a skateboarding video game under development featuring a prominent skateboarder. The advertising company crafts its marketing ideas and ultimately consults with the game designers. The overall video game permits gamers to create and control a skateboarder. These attributes include physical appearance and various unique skills. The gamer's character also can earn additional skills as the overall video game progresses. After the consultation, it is agreed that the advertising spots will appear after the gamer completes a skill level from the overall video game. At this point, the overall video game seamlessly transitions and directs the gamer to a mini event. The gamer's character is the same in terms of physical attributes, mannerisms, and skill as the one he or she had been controlling throughout the preceding level of the overall video game. However, the gamer is tasked with an impossible skateboarding jump that the gamer can control. Since this jump is designed to be impossible, the gamer's character will wipe out in some manner but then get up and dust himself off, unscathed. The computer graphics animation will then visually zoom in to offer a close-up view of the character's helmet, which will bear the logo of the advertising company's protective gear product. The advertising company's catchphrase may then appear in either audio or visual ways. This interlude from the overall video game will typically last no longer than a minute or so. After the completion of the interlude, the overall video game continues without direct reference to the advertising spot. In the preferred embodiment, the present invention segregates events occurring in the advertising interlude from events occurring during play of the overall video game. For example, if a gamer is playing a football video game and he or she engages in an advertising interlude such as a cheerleading contest and the gamer loses the cheerleading contest, that loss will have no bearing on the football game in the preferred embodiment. Alternatively, such a contest could have an effect on the overall video game—for example, because the gamer elicited boos rather than cheers, the boos may carry over into the overall video game. Or, the odds of completing passes or other such game items may go up or down depending on the gamer's performance during the interactive advertising interlude. In other words, the present invention in this alternative embodiment combines events occurring in the advertising interlude with events occurring during play of the overall video game.

An additional embodiment of the present invention relates to a product related in-game AD-Links and Internet browsing feature. With game platforms that are enabled for internet connectivity, the ads in this embodiment contain an Internet link to a given product's website. The game would be paused, thus allowing the player to visit the site for as long as he or she wanted, then return to game play.

In effect, the gamer's product preferences and the resulting related in-game ad are gleaned not only from those preferences he or she expresses with the in-game choices he or she makes (e.g. team, bicycle brand, etc); but also by his/her game console Internet browsing habits. This aspect of the present invention makes use of game preference data. For example, if a player picks the REDSKINS™ as his favorite football team, or the HOYAS™ as his favorite basketball team, or YAMAHA™ as his favorite bike, that data would be collected and links to those team's/sponsor's/manufacturer's Internet merchandising websites to be incorporated into the ad info or automatically “pop-up” in an in-game ad link.

An additional embodiment of the present invention relates to virtual ‘peel-away’ and ‘under-lid’ Product Prizes. Taking a cue from soda pop, “peel-away” and “under-lid” sweepstakes, such promotional features also appear within the mini-game/ad format described above. If the player successfully completes the ad's challenge, they: (a) win a coded prize, they can redeem at the vendor's website by entering the code, (b) win a coded registration which enters them into a sweepstakes to win a “grand prize.”

These embodiments of the present invention work through the use of conventional Internet connectivity components within conventional game consoles. Within ads, at least one link within the game itself is presented. The gamer can choose to pause the game and ultimately click the link to go to the site. From there, the gamer, also referred to as user, can buy a product or otherwise engage in commercial activity. Since conventional game consoles connect with the Internet, the present invention gleans preference information from such items as Web browsing habits via conventional manners like IP address, cookies, etc in order to provide localized or customized services and promotions.

In addition, the present invention offers an incentive for users to use the advertisements. The present invention in an embodiment places coded offers and prizes within the games via conventional means. When a user is successful at mastering a specific skill or achievement within a game, a coded prize offer will become visible. This comes up in the form of a pop up on the screen. Included in this pop up is a code to redeem a prize or product. The user may then click on this link and redeem the prize.

It should be understood that that which has been described above can be accomplished with known conventional technology, including accessing specific xml values or values saved on a memory card to create advertisements.

I claim:

1. A method for interactive advertising, comprising:
formulating a conceived video game while simultaneously developing a conceived advertising campaign;
implementing a consultation between advertisers and video game designers;
commencing an advertisement design and programming, resulting in combining the conceived video game with the conceived advertising campaign;
ensuring computer graphics animation of an advertising interlude mirrors a look and feel of an overall video game gleaned from the conceived video game;
incorporating data from the overall video game via an attributes integration such that a conduit is established for data to shape the advertising interlude;
programming advertising design and the attributes integration into the overall video game;
logging gamer information when the gamer begins use of the overall video game;
recording gamer attributes and the gamer information during use of the overall video game;
programming a natural break in the overall video game, the natural break occurring once a significant event occurs during play of the overall video game;
beginning the advertising interlude once the natural break occurs;
permitting the gamer to interact and control the advertising interlude, the gamer interaction based on the gamer information and the gamer attributes achieved during play of the overall video game; and
returning the gamer to regular play after a conclusion of the advertising interlude.

2. The method for interactive advertising of claim 1, further comprising programming the advertising design and the attributes integration onto the overall video game.

3. The method for interactive advertising of claim 1, further comprising changing the computer graphics animation used by the gamer for other versions via an Internet transfer.

4. The method for interactive advertising of claim 3, further comprising providing at least one of the advertising interlude that is different such that the advertising interlude has different products, scenarios, challenges and products.

5. The method for interactive advertising of claim 1, further comprising taking the gamer information to be within advertisements.

6. The method for interactive advertising of claim 1, further comprising segregating events occurring in the advertising interlude from events occurring during play of the overall video game.

7. The method for interactive advertising of claim 1, further comprising combining events occurring in the advertising interlude with events occurring during play of the overall video game.

8. A method for interactive advertising, comprising:
programming advertising design and attributes integration into an overall video game;
logging gamer information when a gamer begins use of the overall video game;
recording gamer attributes and the gamer information during use of the overall video game;
programming a natural break in the overall video game, the natural break occurring once a significant event occurs during play of the overall video game;
beginning an advertising interlude once the natural break occurs;
permitting the gamer to interact and control the advertising interlude, the gamer interaction based on the gamer information and the gamer attributes achieved during play of the overall video game; and
returning the gamer to regular play after a conclusion of the advertising interlude.
